(19) United States
(12) Patent Application Publication
(10) Pub. No.: US 2022/0164408 A1
(43) Pub. Date: May 26, 2022

(54) SYSTEM AND METHOD OF INTEGRATING COLLABORATION TOOLS

(71) Applicant: RADICAL HQ LIMITED, London (GB)

(72) Inventors: Thomas Petty, London (GB); Andrei Gheorghe, London (GB); Katricia Olearczyk-Reid, London (GB); Sven Over, London (GB); Henry Davies, London (GB); Jackson Gabbard, London (GB); Nimrod Priell, London (GB); Abigail Barsky, Atlanta, GA (US)

(21) Appl. No.: 17/325,662

(22) Filed: May 20, 2021

Related U.S. Application Data
(60) Provisional application No. 63/116,478, filed on Nov. 20, 2020.

(51) Int. Cl. G06F 16/955; G06F 16/957; G06F 40/284; G06F 16/954; G06F 16/951; G06F 16/958

(52) U.S. Cl. CPC G06F 16/9558; G06F 16/957; G06F 16/958; G06F 16/954; G06F 16/951; G06F 40/284

(57) ABSTRACT

A non-transitory computer-readable storage medium having software instructions stored therein, which, when executed by a processor, cause the processor to determine two or more user profile accounts logged in to two or more electronic devices are affiliated with a same organization or two or more affiliated organizations, determine displays of the two or more electronic devices are displaying a same page or a same section of a software product, and display, on each of the displays of the two or more electronic devices, a graphic user interface adjacent to the same page or the same section of the software product. The graphic user interface enables the two or more user profile accounts to collaborate regarding the same page or the same section of the software product.

### CROSS-REFERENCE TO RELATED APPLICATION(S)

The present application claims priority to and the benefit of U.S. Provisional Application No. 63/116,478, filed Nov. 20, 2020, the entire contents of which are incorporated herein by reference.

### BACKGROUND

### 1. Field

The present disclosure relates to various embodiments of a system and a method of integrating collaboration tools.

### 2. Description of Related Art

Work tasks are increasingly frequently being performed remotely utilizing online programs and platforms. However, remote and online work may present an impediment to collaboration between colleagues. Conventional tools and methodologies for collaborating on documents include emailing documents back and forth between various colleagues, calling a colleague to describe a document over the phone, or allowing another user (e.g., IT personnel) to remote log into the user's computer to take control and navigate on the user's computer.

However, these conventional tools and methods for collaborating online are inefficient and may be prone to introducing errors. For instance, emailing documents to several users may lead to inconsistencies between the documents if strict version control protocols are not followed. Additionally, this approach is inefficient because multiple users cannot simultaneously edit the same document. Moreover, describing a document or a page of a software product to a colleague over the phone is inefficient because it can be difficult to describe in words the portion of the document or software product that the user is referencing.

### SUMMARY

The present disclosure relates to various embodiments of non-transitory computer-readable storage medium. In one embodiment, the non-transitory computer-readable storage medium has software instructions stored therein, which, when executed by a processor, cause the processor to determine two or more user profile accounts logged in to two or more electronic devices are affiliated with a same organization or two or more affiliated organizations, determine displays of the two or more electronic devices are displaying a same page or a same section of a software product, and display, on each of the displays of the two or more electronic devices, a graphic user interface adjacent to the same page or the same section of the software product. The graphic user interface enables the two or more user profile accounts to collaborate regarding the same page or the same section of the software product.

The graphic user interface may include a list of the two or more user profile accounts viewing the same page or the same section of the software product, and a message box configured to enable the two or more user profile accounts to share files.

The instructions may further cause the processor to display, on each of the displays of the two or more electronic devices, a viewport of the software product in a first iframe, and to display, on each of the displays of the two or more electronic devices, the graphic user interface in a second iframe adjacent to the first iframe.

The instructions may further cause the processor to parse URLs received from the two or more electronic devices into one or more relevant components and one or more irrelevant components, and compare the relevant components of the URLs to determine the displays of the two or more electronic devices are displaying the same page or the same section of the software product.

The instructions may further cause the processor to compare contents displayed on the displays of the two or more electronic devices utilizing a fuzzy matching algorithm to determine the displays of the two or more electronic devices are displaying the same page or the same section of the software product.

The instructions may further cause the processor to compare Document Object Model (DOM) elements displayed on the displays of the two or more electronic devices to determine the displays of the two or more electronic devices are displaying the same page or the same section of the software product.

The instructions may further cause the processor to synchronize text displayed in a form entry box displayed on the displays of the two or more electronic devices utilizing a conflict-free replicated data type (CRDT) data structure.

The instructions may further cause the processor to send a notification to a first electronic device of the two or more electronic devices in response to a command entered into a form entry box displayed on a display of a second electronic device of the two or more electronic devices.

The instructions may further cause the processor to sample cursor locations of cursors displayed on the displays of the two or more electronic devices, and to display, on each of the displays of the two or more electronic devices, graphical representations of the cursors at the cursor locations.

The instructions may further cause the processor to move a viewport of the software product displayed on a first electronic device of the two or more electronic devices in response to a scroll command entered into a second electronic device of the two or more electronic devices.

The present disclosure also relates to various embodiments of a computer-implemented method of integrating collaboration tools. In one embodiment, the method includes determining two or more user profile accounts are affiliated with a same organization, determining displays of the two or more electronic devices are displaying a same page or a same section of a software product, and displaying, on each of the displays of the two or more electronic devices, a graphic user interface adjacent to the same page or the same section of the software product. The graphic user interface enables the two or more user profile accounts to collaborate regarding the same page or the same section of the software product, and the graphic user interface includes a list of the two or more user profile account viewing the same page or the same section of the software product, and a message box configured to enable the two or more user profile accounts to share files.

The method may also include displaying, on each of the displays of the two or more electronic devices, a viewport of the software product in a first iframe, and displaying, on each of the displays of the two or more electronic devices, the graphic user interface in a second iframe adjacent to the first iframe.

The method may also include parsing URLs received from the two or more electronic devices into one or more relevant components and one or more irrelevant components, and comparing the relevant components of the URLs to determine the displays of the two or more electronic devices are displaying the same page or the same section of the software product.

The method may also include comparing contents displayed on the displays of two or more electronic devices utilizing a fuzzy matching algorithm to determine the displays of the two or more electronic devices are displaying the same page or the same section of the software product.

The method may also include comparing Document Object Model (DOM) elements displayed on the displays of the two or more electronic devices to determine the displays of the two or more electronic devices are displaying the same page or the same section of the software product.

The method may also include synchronizing text displayed in a form entry box displayed on the displays of the two or more electronic devices utilizing a conflict-free replicated data type (CRDT) data structure.

The method may also include sending a notification to a first electronic device of the two or more electronic devices in response to a command entered into a form entry box displayed on a display of a second electronic device of the two or more electronic devices.

The method may also include sampling cursor locations of cursors being displayed on the displays of the two or more electronic devices, and displaying, on each of the displays of the two or more electronic devices, graphical representations of the cursors at the cursor locations.

The method may also include moving a viewport of the software product displayed on a first electronic device of the two or more electronic devices in response to a scroll command entered into a second electronic device of the two or more electronic devices.

A non-transitory computer-readable storage medium according to another embodiment of the present disclosure has software instructions stored therein, which, when executed by a processor, cause the processor to determine two or more user accounts logged in to two or more electronic devices are affiliated with a same organization or two or more affiliated organizations, determine displays of the two or more electronic devices are displaying a same page or a same section of a software product, and transmit instructions to display, on the displays of the two or more electronic devices, a graphic user interface adjacent to the same page or the same section of the software product. The graphic user interface enables collaboration regarding the same page or the same section of the software product. To determine the displays of the two or more electronic devices are displaying a same page or a same section of a software product, the instructions, when executed by the processor, cause the processor to receive a first URL corresponding to a page or section of the software product displayed on a first electronic device of the two or more electronic devices, receive a second URL corresponding to a page or section of the software product displayed on a second electronic device of the two or more electronic devices, parse each of the first URL and the second URL into one or more relevant components and one or more irrelevant components, the one or more irrelevant components including a character string unique to the first user account of the first electronic device or the second user account of the second electronic device, and compare the relevant components of the first and second URLs.

The instructions, when executed by the processor, may cause the processor to ignore the one or more irrelevant components of the first and second URLs to determine the displays of the two or more electronic devices that are displaying the same page or the same section of the software product.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable system or method of integrating collaboration tools.

### BRIEF DESCRIPTION OF THE DRAWINGS

The accompanying drawings, together with the specification, illustrate exemplary embodiments of the present disclosure, and, together with the description, serve to explain the principles of the present disclosure.

FIG. 1 is a schematic view of a system for integrating collaboration tools according to one embodiment of the present disclosure;

FIG. 2 is a schematic view of a display of an electronic device displaying a collaboration tool according to one embodiment of the present disclosure; and

FIG. 3 is a flowchart illustrating tasks of a method of integrating collaboration tools according to one embodiment of the present disclosure.

### DETAILED DESCRIPTION

Aspects of the present disclosure relate to various embodiments of a system and a computer-implemented method of integrating collaboration tools. In one or more embodiments, the system and method of the present disclosure may display the collaboration tools on the displays of electronic devices being operated by two or more users of the same organization (or affiliated organizations) who are viewing the same page or the same section of a software product. The collaboration tools may enable the users to share files (e.g., audio, video, pictures, and other media files, documents, and executables) related to the content of the same page or section of the software product being viewed by the users. In one or more embodiments, the collaboration tools may also enable the users to perform real-time co-editing of form entry boxes on the same page or the same section of the software product, and/or enable the user to perform co-browsing of the page or section of the software product, both of which facilitate collaboration among the users.

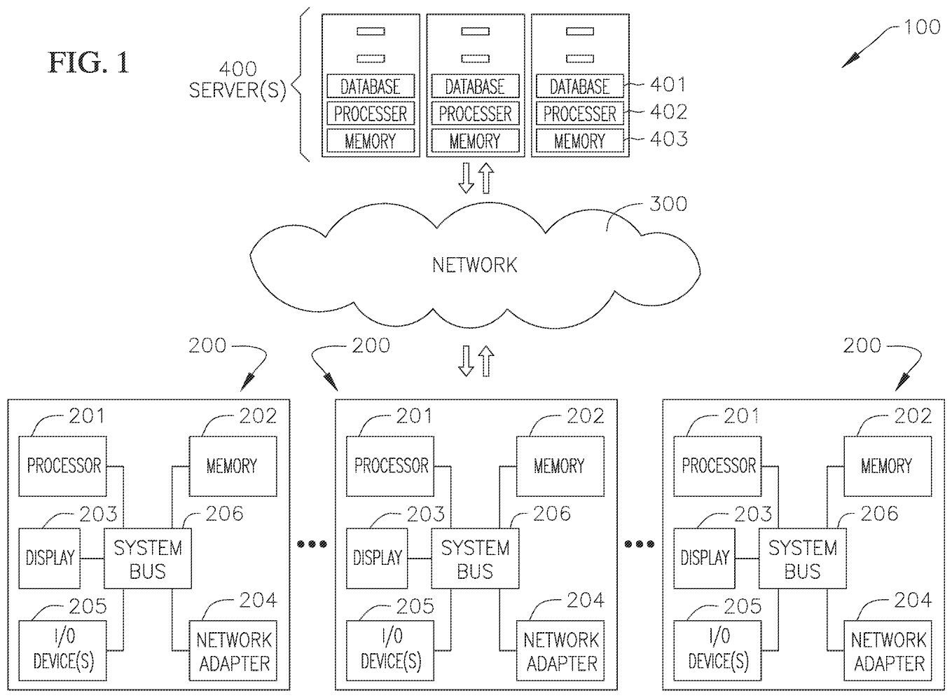

FIG. 1 is a block diagram of a system 100 according to one embodiment of the present disclosure. In the illustrated embodiment, the system 100 includes a series of electronic devices 200 (e.g., desktop computers, cellular phones, tablet computers, wearable electronic devices, or combinations thereof) connected to each other (i.e., configured to electronically communicate with each other) over a data network 300 (e.g., a local area network or a wide area network) via a server 400. In one or more embodiments, the electronic devices 200 may be operated by individuals (e.g., office personnel or other employees) who work for the same organization or related organizations. The number of electronic devices 200 connected to each other over the data network 300 via the server 400 may vary depending on the size of the organization or the sizes of the related organizations. As described in more detail below, the server 400 includes one or more software modules for facilitating and coordinating communications and interactions between the users of the electronic devices 200 when the users are utilizing the electronic devices 200 to view the same page or section (e.g., the same webpage) of a software product (e.g., software as a product (SaaP) or software as a service (Saas)).

In one or more embodiments, the server 400 includes a mass storage device or database 401 such as, for example, a disk drive, drive array, flash memory, magnetic tape, or other suitable mass storage device for storing instructions and information used by the server 400. For example, the database 401 may store personal profile information about the users, interactions between the users, interactions between a user and a software product, business/network data, and/or analysis results (e.g., processed data), amongst other data. In one or more embodiments, the database 401 may store any other relevant information for facilitating interactions between users of the electronic devices 200. Although the database 401 is included in the server 400 as illustrated in FIG. 1, in one or more embodiments, the server 400 may be connected to an external database that is not a part of the server 400, in which case, the database 401 may be used in addition to the external database or be omitted entirely.

The server 400 further includes a processor or central processing unit (CPU) 402, which executes program instructions from memory 403 and interacts with other system components to perform various methods and operations according to one or more embodiments of the present disclosure. The memory 403 is implemented using any suitable memory device, such as a random access memory (RAM), and may additionally operate as a computer-readable storage medium having non-transitory computer readable instructions stored therein that when executed by the processor 402 cause the server 400 to control and manage interactions and facilitate communications between the users using the electronic devices 200 over the data network 300.

In the embodiment illustrated in FIG. 1, each of the electronic devices 200 includes a processor 201, a memory device 202, a display 203 configured to display images, a network adapter 204 configured to communicate with other devices, including the server 400, and one or more input/output (I/O) devices 205 (e.g., a keyboard and a mouse). In the illustrated embodiment, the processor 201, the memory 202, the display 203, the network adapter 204, and the input/output (I/O) device(s) 205 communicate with one another over a system bus 206. In one or more embodiments, the memory 202 may include persistent memory, such as NAND flash memory, for storing instructions.

The term “processor” is used herein to include any combination of hardware, firmware, and software, employed to process data or digital signals. The hardware of a processor may include, for example, application specific integrated circuits (ASICs), general purpose or special purpose central processors (CPUs), digital signal processors (DSPs), graphics processors (GPUs), and programmable logic devices such as field programmable gate arrays (FPGAs). In a processor, as used herein, each function is performed either by hardware configured, i.e., hard-wired, to perform that function, or by more general purpose hardware, such as a CPU, configured to execute instructions stored in a non-transitory storage medium. A processor may be fabricated on a single printed wiring board (PWB) or distributed over several interconnected PWBs. A processor may contain other processors; for example, a processor may include two processors, an FPGA and a CPU, interconnected on a PWB.

As described in more detail below, the memory 403 of the server 400 and/or the memory 202 of the electronic devices 200 store instructions that, when executed by the processor 402, 201, respectively, cause the server 400 and the electronic devices 200 to perform various functions to facilitate collaboration between the users of the electronic devices 200.

In one or more embodiments, the memory 403 of the server 400 stores instructions that, when executed by the processor 402, cause the server 400 to determine if two or more users of the electronic devices 200 (or two or more user profile accounts logged into or signed into the electronic devices 200) are associated with the same organization (e.g., the same company) or are associated with two or more related organizations (e.g., an agency and its client, a vendor and its clients, partner companies, etc.). In one or more embodiments, the instructions stored in memory 403 of the server 400 are configured to determine that two or more users (or two or more user profile accounts) are affiliated with the same organization or two or more related organizations when those users (or user profile accounts) are logged in to the same portal with valid credentials (e.g., a username and password). In one or more embodiments, the database 401 of the server 400 may include a list of authenticated users or user profile accounts (e.g. a lookup table) affiliated with the same organization or related organizations, and the instructions may be configured to compare information (e.g., credentials) received from the electronic devices 200 to the list of authenticated users (or user profile accounts) to determine if two or more users (or user profile accounts) are affiliated with the same organization or two or more related organizations. In one or more embodiments, the list of authenticated users (or user profile accounts) affiliated with the same organization or related organizations may be stored in the database 401 of the server 400 with unique identifying information, such as IP addresses, and the instructions may be configured to compare information received from the electronic devices 200 against the unique identifying information stored in the database 401.

In one or more embodiments, the memory 403 of the server 400 includes instructions that, when executed by the memory 403 of the server 400, cause the server 400 to determine when two or more users or user profile accounts (who or which are affiliated with the same organization or two or more associated organizations, as determined in the manner described above) are viewing the same section or page of the same software product on the displays 203 of the electronic devices 200. That is, in one or more embodiments, the memory 403 of the server 400 includes instructions that, when executed by the memory 403 of the server 400, cause the server 400 to determine when the displays 203 of two or more electronic devices 200, into which two or more users or user profile accounts of the same organization or two or more associated organizations are logged into or signed into, are displaying the same section or the same page of the same software product. For instance, in one or more embodiments, the instructions are configured to determine when two or more users (or user profile accounts) are simultaneously viewing the same dashboard of an analytics products or the same page of a Customer Relationship Management (CRM) software product. In one or more embodiments, the memory 403 stores a series of heuristics (e.g., a rules engine) configured to determine whether two or more of the users of the electronic devices 200 are viewing the same portion or page of a software product on the displays 203 of the electronic devices 200 (i.e., determine whether the displays 203 of the electronic devices 200 into which two or more users of the same or affiliated organized are logged into are displaying the same portion or page of a software product). For example, in one or more embodiments, the memory 403 stores a heuristic configured to parse the URLs of the pages being viewed by the users on the displays 203 of the electronic devices 200 into its constituent components including one or more relevant portions and one or more irrelevant portions, compare the relevant portion(s) of the parsed URLs, and determine that two or more users are viewing the same portion or page of the software product when there is a match between the relevant portion(s) of the parsed URLs. Some software products may display URLs a portion of which contains characters (e.g., an alphanumeric string) that are unique to each individual user (or each individual user profile account) even when the users are viewing the same fundamental page or content of the software product. Accordingly, these portions of the URLs may not match even if the users are viewing the same fundamental page or content of the software product. For instance, the URL for one user viewing a page or section of a software product may be “www.HRSoftware.com/1a2qr896/payroll” and the URL for another user viewing the same page or section of the software product may be “www.HRSoftware.com/7x9by273/payroll.”

In one or more embodiments, the heuristic may drop or disregard this portion of the URLs associated with the particular user or user profile account (e.g., the heuristic may drop the character strings “12qr896” and “7x9by273” in the example URLs above) when performing the comparison, and may compare only the remaining portion(s) of the URLs.

In one or more embodiments, the heuristics stored in the memory 403 of the server 400 may be configured to compare other information to determine if two or more users are viewing the same content or the same page of the software product. That is, in one or more embodiments, the heuristics stored in the memory 403 of the server 400 may be configured to determine when the displays 203 of two or more electronic devices 200, into which two or more users or user profile accounts of the same organization or two or more associated organizations are logged into or signed into, are displaying the same section or the same page of the same software product. For instance, in one or more embodiments, the memory 403 may store a heuristic configured to compare the content on the page or the portion of the software product being viewed on the displays 203 of the electronic devices 200 by the users. In one or more embodiments, the heuristic may utilize content fuzzy matching (i.e., a fuzzy matching algorithm) to compare the content being displayed on the displays 203 of the electronic devices 200 to be viewed by the users. In one or more embodiments, the memory 403 may store a heuristic configured to compare headers (or parts of the headers) of the page or the portion of the software product being displayed on the displays 203 of the electronic devices 200 to be viewed by the users. In one or more embodiments, the heuristic may utilize XPaths or any other suitable Document Object Model (DOM) parsing function to compare the content of the pages being displayed on the displays 203 of the electronic devices 200 to be viewed by the users. In one or more embodiments, the memory 403 may store a heuristic configured to compare cookies that are loaded by the electronic devices 200 when displaying a software product, and/or compare portion(s) of data stored on the electronic devices 200 in the web browser's local storage to determine if two or more of the displays 203 are displaying the same content or the same page of the software product to be viewed by the users.

In one or more embodiments, the heuristics may include any suitable combination of two or more of the heuristics referenced above (e.g., URL parsing and matching, content fuzzy matching, and/or header matching). In one or more embodiments, the heuristics may vary depending on the specific software product being utilized by the users. Additionally, in one or more embodiments, the heuristics may be defined dynamically by one or more users or by the organization(s) employing the users. Accordingly, the heuristics may be different for different organizations utilizing the same software product. Additionally, in one or more embodiments, the heuristics may be set dynamically by an organization such that the organization can determine when two or more users are viewing the same page or the same content on non-publicly available software products (e.g., software products for which an API is not available).

In one or more embodiments, the database 401 of the server 400 may contain a mapping of pages or sections of the software product to unique hashes (e.g., a lookup table associating individual pages or sections of the software product to unique hashes). The specific details (e.g., URL, headers, and content) of the pages of the software product may be mapped to a unique hash using an irreversible hash function (e.g., the MD5 message-digest algorithm) and the unique hash(es) associated with the page or section of the software product displayed on the displays 203 to be viewed by the users may be transmitted from the electronic devices 200 to the server(s) 400 over the network 300. In one or more embodiments, the memory 202 of each of the electronic devices 200 stores instructions which, when executed by the processor 201, cause the processor 201 to generate a unique hash (e.g., utilizing an irreversible hash function, such as the MD5 message-digest algorithm) based on the details (e.g., URL, DOM headers, and/or content) of the page or section of the software product being displayed on the display 203 of the electronic device 200, and to transmit this unique hash to the server 400 over the network 300. The instructions stored in the memory 403 of the server 400, when executed by the processor 402, may cause the processor 402 to compare the hash value(s) received from each of the electronic devices 200 and determine that the electronic devices 200 transmitting the same hash value(s) are displaying the same page or section of the software product. In this manner, organizations may avoid transmitting or otherwise exposing the content of its software product over the network 300.

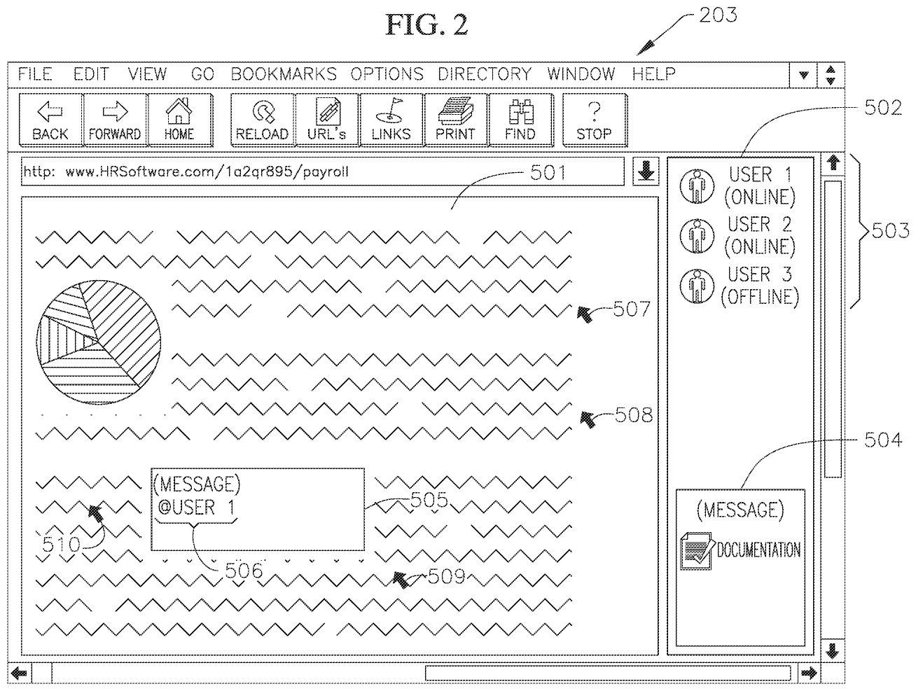

In one or more embodiments, the memory 403 of the server 400 includes instructions that, when executed by the processor 402, cause the server 400 to transmit a signal over the network 300 to each of the electronic devices 200 of the users (or user profile accounts) who are viewing the same page or the same section of the software product, as determined in the manner described above. That is, in one or more embodiments, the memory 403 of the server 400 includes instructions that, when executed by the processor 402, cause the server 400 to transmit a signal over the network 300 to each of the electronic devices 200 into which two or more users or user profile accounts of the same organization or two or more associated organizations are logged into or signed into and which are displaying on the displays 203 the same section or the same page of the same software product. In one or more embodiments, the signal transmitted from the server 400 to the electronic devices 200 includes instructions which, when executed by the processors 201 electronic devices 200 of the users who are viewing the same page or the same content of the software product, causes the displays 203 (e.g., the monitor of the computer or the screen of the smartphone) of the electronic devices 200 to display a user interface (e.g., a toolbar) adjacent to the content of the software product being displayed on the displays 203 to be viewed by the users. In one or more embodiments, the signal from the server 400 may be transmitted only to those electronic devices 200 that users or user profile accounts associated with the same organization or affiliated organizations are logged into or signed into, and the displays 203 of which are displaying the same page or the same section of the same software product. FIG. 2 depicts an exemplary embodiment of a display 203 of an electronic device 200 displaying a first window or frame 501 displaying a viewport of a page or section of a software product (i.e., the user's visible area of the page or section of the software product), and a second window or frame 502 adjacent or next to the first window 501 displaying a user interface (e.g., a sidebar) configured to enable two or more users to collaborate and share content related to the page or content of the software product being displayed in the first window 501.

In one or more embodiments, the instructions transmitted from the server 400 to the electronic devices 200 of the users (or user profile accounts) who are viewing the same page or the same content of the software product, when executed by the processor 402 of each of the electronic devices 200, cause the displays 203 of the electronic devices 200 to display the page or content of the software product in a first iframe 501 (i.e., a first HTML inline frame) and to display the user interface (e.g., the toolbar) in a second iframe 502 (i.e., a second HTML inline frame) adjacent to the first iframe 501. In the illustrated embodiment, the second iframe 502 containing the user interface (e.g., the toolbar) is positioned along a right side edge of the first iframe 501, although in one or more embodiments the second iframe 502 may be positioned in any other suitable location relative to the first iframe 501 (e.g., along a lower edge of the first iframe 501, along a left side edge of the first iframe 501, or along an upper edge of the first iframe 501). Accordingly, in the illustrated embodiment, the user interface (e.g., the toolbar) is rendered next to the content of the software product (e.g., webpage) being viewed by two or more users (or two or more different user profile accounts), rather than rendered overlaid on the content of the software product. In one or more embodiments, the DOM tree of the software product includes instructions that, when executed by the processors 201 of the electronic devices 200, cause the electronic devices 200 to narrow a viewport of the software product to fit within the first iframe 501.

In one or more embodiments, the instructions transmitted to the electronic devices 200 by the server 400 (or stored in the memory 202 of the electronic devices 200) include cascading style sheets (CSS) rules for the software product that are configured to address how the software product will react when its viewport is resized to fit into the first iframe 501, when the user interface (e.g., the toolbar) is generated in the second iframe 502 adjacent to the first iframe 501, when a user inputs data (e.g., text and/or media) into the software product or the user interface, and/or when any other actions are performed. These CSS rules are configured to ensure that both the content of the software product and the user interface (e.g., the toolbar) are displayed properly (e.g., the user interface is not blocked or obscured by the content of the software product displayed in the first iframe). These CSS rules may vary depending on the software product and the functionality of the software product (e.g., animations on the software product or JavaScript code that is triggered on the software product).

In the illustrated embodiment, the instructions transmitted to the electronic devices 200 by the server 400 (or stored in the memory 202 of the electronic devices 200), when executed by the processor 201 of each of the electronic devices 200, cause the displays 203 of the electronic devices 200 to display, in the user interface, a list of the other users (or other user profile accounts) that are viewing the same section or page of the software product, as determined in the manner described above. For instance, as illustrated in FIG. 2, the user interface includes a list of all other user(s) or user profile account(s) 503 viewing the same section or page of the software product. In one or more embodiments, each electronic device 200 may transmit, via the network adapter 204, a signal to the server 400 over the network 300 containing a hash value associated with the section or page of the software product that the user of the electronic device 200 is viewing on the display 203. The software module of the server 400 may then compare the hash values received from each of the electronic devices 200. The server 400 may then transmit, to each of the electronic devices 200 that transmitted the same hash value, a signal over the network 300 containing information regarding the identity of the other user(s) viewing the same section or page of the software product. The hash values may be transmitted from the electronic devices 200 to the server 400 periodically (e.g., at regular intervals) or upon the occurrence of certain events (e.g., the user navigating to a different section or page of the software product). In one or more embodiments, the hash values may be transmitted to the server 400 via websockets from the web browsers being operated on the electronic devices 200 to display the software product. In one or more embodiments, the list of users 503 displayed in the user interface may be less than all of the users who are viewing the same page or section of the software product (e.g., the list of users 503 displayed in the user interface may be a subset of all of the users viewing the same page or section of the software product). In one or more embodiments, the user interface may include a filter configured to enable the users to specify criteria (i.e., one or more parameters) for determining which subset of users (or user profile accounts) among all of the users (or user profile accounts) viewing the same page or section of the software product should be displayed in the user interface. Additionally, in one or more embodiments, the list of users 503 displayed in the user interface may also display various information about the users or the user profile accounts, such as the users' profile data and activity state (e.g., online or offline). The users' activity state may be transmitted and communicated to the other users by standard browser hooks.

In the illustrated embodiment, the user interface enables communications and interactions between the users of the electronic devices 200 that are viewing the same section or page of the software product. For instance, as illustrated in FIG. 2, the user interface includes a message box 504 configured to enable users viewing the same section or page of the software product to share files (e.g., audio, video, pictures, and other media files, documents, and executables); take and share a screenshot (with or without annotations) of the section or page of the software product; share, edit, and delete messages; leave a voice message and/or screen-grab video; initiating a real-time voice of video conversation utilizing the microphone and/or the video camera of the electronic device (e.g., the laptop or cell phone), which may be recorded and left for subsequent listening and/or viewing by other users viewing the same section or page of the software product.

In one or more embodiments, the memory 202 of each of the electronic devices 200 includes instructions that, when executed by the processor 201, cause the processor 201 to identify form entry boxes (e.g., textarea boxes) contained in the section or page of the software product being displayed on the displays 203 to be viewed by the users, and to synchronize any text written into these form entry boxes between all of the displays 203 displaying that section or page of the software product containing the form entry boxes. In one or more embodiments, the text written into the form entry boxes may be synchronized between the users by utilizing a conflict-free replicated data type (CRDT) data structure in which the text input into the form entry box by one user is replicated and stored on the other users' electronic devices 200. The replicas stored on the other users' electronic devices 200 may be modified independently of any other replica (i.e., optimistic replication), and then CRDT may be utilized to merge the various modified replicas from the users into a consistent state. FIG. 2 depicts a form entry box 505 displayed in the first iframe 501 containing text (e.g., “ABCD”) entered by a first user, text (e.g., “1234”) entered by a second user, and text (e.g., “X1Y2”) entered by a third user.

In one or more embodiments, the memory 202 of each of the electronic devices 200 includes instructions that, when executed by the processor 201, cause the processor 201 to perform certain functions when commands are entered into a form entry box on the section or page of the software product. For instance, in one or more embodiments, when a user's profile name is typed into a text box preceded by a special character (e.g., “@”), the software instructions are configured to send a notification to the electronic device 200 of the user (or the user profile account) associated with the profile name that was typed, and to invite that user to view the section or page of the software product in which the user's profile name was typed. Additionally, in one or more embodiments, when a user's profile name preceded by a special character is typed into the text box, the instructions are configured to render a graphical element on the display 203 of the electronic device 200, and when the user hovers the cursor over the rendered graphical element, the instructions are configured to display various information about the user, such as the user's profile data and activity state (e.g., online or offline). FIG. 2 depicts a command (“@user1”) 506 that has been entered into the form entry box 505 to send a command to “user1”. In one or more embodiments, the memory 202 of each of the electronic devices 200 may include instructions that, when executed by the processor 201, cause the processor 201 to perform certain functions when commands are entered into the message box 504.

In one or more embodiments, the memory 403 of the server 400 includes instructions that, when executed by the processor 402, cause the server 400 to enable co-browsing between the two or more electronic devices 200 simultaneously displaying the same section or page of the software product. In one or more embodiments, the instructions stored in the memory 403 of the server 400, when executed by the processor 402, cause the processor 402 to calculate or otherwise determine the locations of the cursor for each of the users (or user profile accounts) simultaneously viewing the same section or page of the software product. These cursor locations may be transmitted from the electronic devices 200 to the server 400 over the network 300. The instructions stored on the server 400, when executed by the processor 402, may cause the server 400 to transmit a signal containing instructions to each of the electronic devices 200 to render graphical representations of those cursor locations on the displays 203 of each of the other users (or user profile accounts) viewing the same section or page of the software product. In this manner, each of the users (or user profile accounts) simultaneously viewing the same section or page of the software product can view the cursor locations of all of the other users (or user profile accounts) that are simultaneously viewing the same section or page of the software product, which enables the users to collaborate regarding the content displayed in the section or page of the software product. In one or more embodiments, the graphical representations of the cursors may vary for different users. Furthermore, in one or more embodiments, the graphic representations of the cursors may contain information identifying the user (or the user profile account) associated with that cursor (e.g., cursors may include a color-coded legend or the username of the user associated with that user or user profile account). FIG. 2 depicts a first cursor 507 that is controlled by the user viewing the display 203 of the electronic device 200, a second cursor 508 the position of which is controlled by “user1,” a third cursor 509 the position of which is controlled by “user2,” and a fourth cursor 510 the position of which is controlled by “user3.”

In one or more embodiments, the location of each cursor may be identified as X- and Y-coordinates expressed in relative distances to other elements found on the projected horizontal and vertical lines passing through the cursor location (e.g., the locations of the cursors may be expressed relative to the location(s) of one or more DOM elements in the browser's internal representation of the section or page of the software product being viewed). Mapping the relative positions of the cursor locations enables the instructions to accurately represent the locations of the other users' cursors even if the other users are viewing the software product at a different resolution, or if the users are viewing the software product on different devices (e.g., a smartphone and a laptop computer) having different screen sizes, or if the users have modified the height and/or width of the first iframe 501 displaying the section or page of the software product. In one or more embodiments, the locations of the cursors may be sampled at a regular interval (e.g., approximately every 200 milliseconds (ms)) or upon the occurrence of certain events (e.g., movement of the cursor). Additionally, in one or more embodiments, the server 400 is configured to transmit a signal containing instructions to each of the electronic devices 200 to generate a graphic animation between two consecutive positions of each of the cursors (e.g., utilizing linear interpolation) to depict each of the cursors smoothly moving between the various cursor locations that are sampled at regular intervals or upon the occurrence of a certain event. That is, in one or more embodiments, the instructions sent to the electronic devices 200 are configured to generate an animation between the location of the cursor sampled at one point in time and the location of the cursor subsequently sampled at a later point in time (e.g., 200 ms later).

In one or more embodiments, one of the two or more users (or user profile accounts) simultaneously viewing the same section or page of the software product may be designated a “leader,” and the operations (e.g., scrolling, clicking, and/or navigating) performed by the “leader” may be replicated on the displays 203 of the other users (or user profile accounts) simultaneously viewing the same section or page of the software product. For instance, in one or more embodiments, the scroll position of the “leader” may be transmitted to the server 400 at regular intervals (e.g., every 200 ms) or upon the occurrence of an event (e.g., a scroll event), and the server 400 may transmit to the electronic devices 200 of each of the users (or user profile accounts) viewing the same page or section of the software product a signal containing instructions to display on the displays 203 of those electronic devices 200 a viewport corresponding to the viewport of the “leader.” In this manner, each of the users may see the same portion of the software product as the “leader” as the “leader” scrolls up and down. Additionally, in one or more embodiments, hyperlink clicks or other navigations performed by the “leader” may be transmitted to the server 400 and then transmitted by the server 400 to the electronic devices 200 being used by the other users.

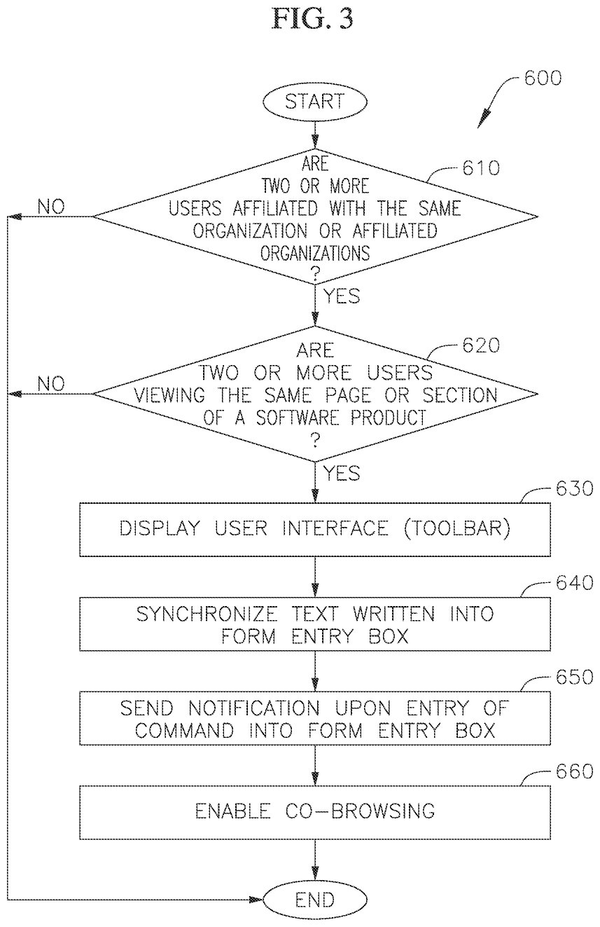

FIG. 3 is a flowchart depicting tasks of a method 600 of displaying integrated collaboration tools on the displays of two or more electronic devices being operated by two or more users of the same organization (or two or more affiliated organizations) who are viewing the same page or the same section of a software product (e.g., SaaP or SaaS product). In one or more embodiments, the method of the present disclosure may be performed utilizing a non-transitory computer-readable storage medium (e.g., computer memory) having software instructions (e.g., a software program) stored therein. The non-transitory computer readable storage medium and the software instructions stored therein are provided at two or more electronic devices (e.g., desktop computers, laptop computers, cellular phones, wearable electronic devices, or combinations thereof) operated by the users and/or at a server in electronic communication with the two or more electronic devices.

In the illustrated embodiment, the method 600 includes an operation 610 of determining if two or more of the users of the electronic devices (or two or more user profile accounts logged into or signed into the electronic devices) are affiliated with the same organization (e.g., the users are employees of the same company) or two or more affiliated organizations (e.g., the users are employed by an agency and its client, a vendor and its clients, partner companies, etc.). In one or more embodiments, the operation 610 may include referencing a list or table stored in the memory of the server of the users or user profile accounts that are affiliated with the same organization or affiliated organizations (e.g., the instructions stored in the memory of the server may include a list of user profiles or IP addresses that are affiliated with the same organization or affiliated organizations). In one or more embodiments, the operation 610 may determine that the two or more users (or the two or more user profile accounts) are affiliated with the same organization or two or more related organizations when the two or more users (or the two or more user profile accounts) are logged in to the same portal with valid credentials (e.g., a valid username and password).

In the illustrated embodiment, the method 600 also includes an operation 620 of determining if two or more of the users (or user profile accounts) affiliated with the same organization or related organizations (as determined in operation 610 above), are viewing the same page or the same section of the same software product on their displays. In one or more embodiments, the operation 620 includes determining if the displays of the electronic devices into which the user profile accounts are logged into or signed into are displaying the same page or the same section of the same software product. In one or more embodiments, the operation 620 includes applying one or more heuristics (e.g., a rules engine) stored in the memory of the server. In one embodiment, the operation 620 includes receiving the URL of the page or section being viewed by each of the two or more users (or the two or more user profile accounts), and applying a heuristic to parse the URL into its constituent components including one or more relevant portions and one or more irrelevant portions, and compare the relevant portion(s) of the URLs. As described above, some software products may display different URLs for users viewing the same page or section of the software product (e.g., the software product may display URLs a portion of which contains characters that are unique to each individual user) and in one or more embodiments, the heuristic applied in operation 620 may drop or disregard this portion of the URLs associated with the particular users (or the particular user profile accounts) when performing the comparison, and may compare only the remaining portion(s) of the URLs. In one or more embodiments, for each of the URLs for which there is a match between the relevant constituent components of the URLs, the operation 620 determines that the two or more users (or the two or more user profile accounts) viewing those URLs are viewing the same page or the same section of a software product (i.e., the displays of the electronic devices into which the user profile accounts are logged into or signed into a displaying the same page or the same section of a software product). In one or more embodiments, the operation 620 may utilize a heuristic stored in the memory of the server to compare the content on the page or the section of the software product being viewed by the users of the electronic devices (i.e., a heuristic to compare the content displayed on the displays of the electronic devices). In one or more embodiments, the heuristic may utilize content fuzzy matching (i.e., a fuzzy matching algorithm) to compare the content being viewed by the users (or at least displayed on the displays of the electronic devices). In one or more embodiments, the heuristic utilized in operation 620 may be configured to compare headers (or parts of the headers) of the page or the portion of the software product being viewed by the users (or at least displayed on the displays of the electronic devices). In one or more embodiments, the heuristic utilized in operation 620 may utilize XPaths or any other suitable Document Object Model (DOM) parsing function to compare the content of the pages being viewed by the users (or at least displayed on the displays of the electronic devices). In one or more embodiments, the heuristic utilized in operation 620 may compare cookies that are loaded by the electronic devices when displaying a software product, and/or compare portion(s) of data stored on the electronic devices in the web browser's local storage. In one or more embodiments, in operation 620, each of the electronic devices may generate and transmit to the server a unique hash (e.g., utilizing an irreversible hash function, such as the MD5 message-digest algorithm) based on the page or section of the software product being viewed by the user, and instructions stored in the memory of the server may compare the hashes to determine which of the users (or the user profile accounts) are viewing the same page or section of the software product (or at least which of the displays of the electronic devices are displaying the same page or section of the software product).

In the illustrated embodiment, the method 600 also includes an operation 630 of displaying, on the displays being viewed by the two or more of the users (or user profile accounts) affiliated with the same organization or related organizations (as determined in operation 610 above) and viewing the same page or section of the software product (as determined in operation 620 above), a user interface (e.g., a toolbar) configured to enable the users to collaborate regarding the content displayed on the page or section of the software product being viewed by the users. That is, in one or more embodiments, the operation 630 includes displaying, on the displays of the electronic devices in which two or more users or user profile accounts associated with the same organization or related organizations (as determined in operation 610 above) are logged in or signed in, and displaying the same page or section of the software product (as determined in operation 620 above), a user interface (e.g., a toolbar) configured to enable collaboration regarding the content on the page or section of the software product being displayed by the displays. In one or more embodiments, the operation 630 may be performed by transmitting a signal from the server to the electronic devices operated by the users containing instructions which, when executed by the processors of the electronic devices, cause the displays of the electronic devices to display the user interface. In one or more embodiments, the operation 630 may include transmitting the signal from the server only to those electronic devices that users or user profile accounts associated with the same organization or affiliated organizations are logged into or signed into, and the displays of which are displaying the same page or the same section of the same software product. In one or more embodiments, the operation 630 includes displaying, on the display of each user (or each user profile account) affiliated with the same organization or related organizations and viewing the same page or section of a software product, a first iframe (i.e., a first HTML inline frame) containing the page or section of the software product, and a second iframe (i.e., a second HTML inline frame) containing a user interface (e.g., a toolbar) adjacent to the first iframe. The second iframe displayed in operation 630 may have any suitable position and orientation relative to the first iframe (e.g., the second iframe may be positioned along a right side edge of the first iframe, along a lower edge of the first iframe, along a left side edge of the first iframe, or along an upper edge of the first iframe). In one or more embodiments, the operation 630 of displaying the user interface may include resizing (e.g., narrowing) the viewport of the software product to fit within the first iframe, and displaying the user interface in the second iframe in a manner that does not negatively affect the appearance, performance, or functionality of the software product displayed in the first iframe or the user interface displayed in the second iframe. For instance, in one or more embodiments, the operation 630 may utilize cascading style sheets (CSS) rules for the software product that are configured to address how the software product will react when its viewport is resized to fit into the first iframe, when the user interface (e.g., the toolbar) is generated in the second iframe adjacent to the first iframe, when a user inputs data (e.g., text and/or media) into the software product or the user interface, and/or when any other actions are performed.

In one or more embodiments, the user interface displayed in operation 630 may include a list of all of the other users or user profile accounts (or a subset of all of the users or user profile accounts) that are viewing the same section or page of the software product, and a message box configured to enable users viewing the same section or page of the software product to share files (e.g., audio, video, pictures, and other media files, documents, and executables); take and share a screenshot (with or without annotations) of the section or page of the software product; share, edit, and delete messages; leave a voice message and/or screen-grab video; initiate a real-time voice of video conversation utilizing the microphone and/or the video camera of the electronic device (e.g., the laptop or cell phone), which may be recorded and left for subsequent listening and/or viewing by other users viewing the same section or page of the software product (e.g., as shown in FIG. 2).

In the illustrated embodiment, the method 600 also includes an operation 640 of synchronizing the text written into any form entry boxes (e.g., any textarea boxes) contained in the page or the section of the software product among the users affiliated with the same organization or related organizations (as determined in operation 610 above) and viewing the same page or section of the software product (as determined in operation 620 above). Following operation 640, the text added, deleted, or modified by any of the users is replicated and displayed in the form entry box being viewed by each of the users such that all of the users are viewing the same text in the form entry box. In one or more embodiments, the operation 640 may utilize a conflict-free replicated data type (CRDT) data structure in which the text input into the form entry box by one user is replicated and stored on the other users' electronic devices. The replicas stored on the other users' electronic devices may be modified independently of any other replica (i.e., optimistic replication), and then CRDT may be utilized to merge the various modified replicas from the users into a consistent state. In this manner, operation 640 enables real-time shared editing by the users of form entry boxes appearing on the page or section of the software product being viewed by the users. In one or more embodiments, the method 600 may not include the operation 640 of synchronizing text written into the form entry box(es).

In one or more embodiments, the method 600 includes an operation 650 of sending a notification or an alert to the one or more electronic devices operated by one or more of the users when a command is entered, by another user, into a form entry box appearing on the section or page of the software product being viewed by the users or into the message box of the user interface displayed in operation 630. For instance, in one or more embodiments, when a user's profile name is typed into a text box preceded by a special character (e.g., “@”), the operation 650 may send a notification to the electronic device operated by the user associated with the profile name that was typed, and invite the user to view the section or page of the software product in which the user's profile name was typed. Additionally, in one or more embodiments, when a user's profile name preceded by a special character is typed into the form entry box or the message box, the operation 650 is configured to render a graphical element, and when the user hovers the cursor over the rendered graphical element, the operation 650 is configured to display various information about the user, such as the user's profile data and activity state (e.g., online or offline). In one or more embodiments, the method 600 may not include the operation 650 of sending a notification when a command is entered into the form entry box(es).

In the illustrated embodiment, the method 600 includes an operation 660 of enabling co-browsing between the users (or the user profile accounts) affiliated with the same organization or related organizations (as determined in operation 610 above) and viewing the same page or section of the software product (as determined in operation 620 above). In one or more embodiments, the operation 660 may include a task of sampling the cursor locations of the users (e.g., at a regular interval, such as 200 ms, or upon the occurrence of a specified event, such as movement of the cursor), and generating graphic representations of the cursor locations of all of the users on the display for each of the users (e.g., as illustrated in FIG. 2). Additionally, in one or more embodiments, the operation 660 includes generating a graphic animation between two consecutive positions of each of the cursors (e.g., utilizing linear interpolation) to depict each of the cursors smoothly moving between the various cursor locations that are sampled at regular intervals or upon the occurrence of a certain event. In this manner, each of the users simultaneously viewing the same section or page of the software product can view the cursor locations of all of the other user that are simultaneously viewing the same section or page of the software product, which facilitates collaboration between the users regarding the content of the software product being displayed. Furthermore, in one or more embodiments, the operation 660 includes designating one of the users as a “leader” and replicating the operations (e.g., scrolling, clicking, and/or navigating) performed by the “leader” on the displays of the other users simultaneously viewing the same section or page of the software product. In this manner, each of the users may see the same portion of the software product as the “leader” as the “leader” scrolls up and down, clicks on one or more links, and otherwise navigates, which facilitates collaboration between the users. In one or more embodiments, the method 600 may not include the operation 660 of enabling co-browsing.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described systems and methods of operation can be practiced without meaningfully departing from the principles, spirit, and scope of this invention, as set forth in the following claims, and equivalents thereof.

What is claimed is:

1. A non-transitory computer-readable storage medium having software instructions stored therein, which, when executed by a processor, cause the processor to:
determine two or more user profile accounts logged in to two or more electronic devices are affiliated with a same organization or two or more affiliated organizations;
determine displays of the two or more electronic devices are displaying a same page or a same section of a software product; and
display, on each of the displays of the two or more electronic devices, a graphic user interface adjacent to the same page or the same section of the software product,
wherein the graphic user interface enables the two or more user profile accounts to collaborate regarding the same page or the same section of the software product.

2. The non-transitory computer-readable storage medium of claim 1, wherein the graphic user interface comprises a list of the two or more user profile accounts viewing the same page or the same section of the software product, and a message box configured to enable the two or more user profile accounts to share files.

3. The non-transitory computer-readable storage medium of claim 1, wherein the software instructions, when executed by the processor, further cause the processor to:
display, on each of the displays of the two or more electronic devices, a viewport of the software product in a first iframe; and
display, on each of the displays of the two or more electronic devices, the graphic user interface in a second iframe adjacent to the first iframe.

4. The non-transitory computer-readable storage medium of claim 1, wherein the software instructions, when executed by the processor, further cause the processor to:
parse URLs received from the two or more electronic devices into one or more relevant components and one or more irrelevant components; and
compare the relevant components of the URLs to determine the displays of the two or more electronic devices are displaying the same page or the same section of the software product.

5. The non-transitory computer-readable storage medium of claim 4, wherein the software instructions, when executed by the processor, further cause the processor to compare contents displayed on the displays of the two or more electronic devices utilizing a fuzzy matching algorithm to determine the displays of the two or more electronic devices are displaying the same page or the same section of the software product.

6. The non-transitory computer-readable storage medium of claim 5, wherein the software instructions, when executed by the processor, further cause the processor to compare Document Object Model (DOM) elements displayed on the displays of the two or more electronic devices to determine the displays of the two or more electronic devices are displaying the same page or the same section of the software product.

7. The non-transitory computer-readable storage medium of claim 1, wherein the software instructions, when executed by the processor, further cause the processor to:
synchronize text displayed in a form entry box displayed on the displays of the two or more electronic devices utilizing a conflict-free replicated data type (CRDT) data structure.

8. The non-transitory computer-readable storage medium of claim 1, wherein the software instructions, when executed by the processor, further cause the processor to:
send a notification to a first electronic device of the two or more electronic devices in response to a command entered into a form entry box displayed on a display of a second electronic device of the two or more electronic devices.

9. The non-transitory computer-readable storage medium of claim 1, wherein the software instructions, when executed by the processor, further cause the processor to:
sample cursor locations of cursors displayed on the displays of the two or more electronic devices; and
display, on each of the displays of the two or more electronic devices, graphical representations of the cursors at the cursor locations.

10. The non-transitory computer-readable storage medium of claim 1, wherein the software instructions, when executed by the processor, further cause the processor to:
move a viewport of the software product displayed on a first electronic device of the two or more electronic devices in response to a scroll command entered into a second electronic device of the two or more electronic devices.

11. A computer-implemented method of integrating collaboration tools, the method comprising:
determining two or more user profile accounts are affiliated with a same organization;
determining displays of the two or more electronic devices are displaying a same page or a same section of a software product; and
displaying, on each of the displays of the two or more electronic devices, a graphic user interface adjacent to the same page or the same section of the software product,
wherein the graphic user interface enables the two or more user profile accounts to collaborate regarding the same page or the same section of the software product, and
wherein the graphic user interface comprises a list of the two or more user profile accounts viewing the same page or the same section of the software product, and a message box configured to enable the two or more user profile accounts to share files.

12. The method of claim 11, further comprising:
displaying, on each of the displays of the two or more electronic devices, a viewport of the software product in a first iframe; and
displaying, on each of the displays of the two or more electronic devices, the graphic user interface in a second iframe adjacent to the first iframe.

13. The method of claim 11, further comprising:
parsing URLs received from the two or more electronic devices into one or more relevant components and one or more irrelevant components; and
comparing the relevant components of the URLs to determine the displays of the two or more electronic devices are displaying the same page or the same section of the software product.

14. The method of claim 13, further comprising comparing contents displayed on the displays of two or more electronic devices utilizing a fuzzy matching algorithm to determine the displays of the two or more electronic devices are displaying the same page or the same section of the software product.

15. The method of claim 14, further comprising comparing Document Object Model (DOM) elements displayed on the displays of the two or more electronic devices to determine the displays of the two or more electronic devices are displaying the same page or the same section of the software product.

16. The method of claim 11, further comprising synchronizing text displayed in a form entry box displayed on the displays of the two or more electronic devices utilizing a conflict-free replicated data type (CRDT) data structure.

17. The method of claim 11, further comprising sending a notification to a first electronic device of the two or more electronic devices in response to a command entered into a form entry box displayed on a display of a second electronic device of the two or more electronic devices.

18. The method of claim 11, further comprising:
sampling cursor locations of cursors being displayed on the displays of the two or more electronic devices; and
displaying, on each of the displays of the two or more electronic devices, graphical representations of the cursors at the cursor locations.

19. The method of claim 11, further comprising moving a viewport of the software product displayed on a first electronic device of the two or more electronic devices in response to a scroll command entered into a second electronic device of the two or more electronic devices.

20. A non-transitory computer-readable storage medium having software instructions stored therein, which, when executed by a processor, cause the processor to:
determine two or more user accounts logged in to two or more electronic devices are affiliated with a same organization or two or more affiliated organizations;
determine displays of the two or more electronic devices are displaying a same page or a same section of a software product, comprising:
receive a first URL corresponding to a page or section of the software product displayed on a first electronic device of the two or more electronic devices;
receive a second URL corresponding to a page or section of the software product displayed on a second electronic device of the two or more electronic devices;
parse each of the first URL and the second URL into one or more relevant components and one or more irrelevant components, the one or more irrelevant components including a character string unique to the first user account of the first electronic device or the second user account of the second electronic device; and
compare the relevant components of the first and second URLs to determine the displays of the two or more users are displaying the same page or the same section of the software product; and
transmit instructions to display, on the displays of the two or more electronic devices, a graphic user interface adjacent to the same page or the same section of the software product,
wherein the graphic user interface enables collaboration regarding the same page or the same section of the software product.

21. The non-transitory computer-readable storage medium of claim 20, wherein the software instructions, when executed by the processor, cause the processor to ignore the one or more irrelevant components of the first and second URLs to determine the displays of the two or more electronic devices that are displaying the same page or the same section of the software product.
